(19) United States
(12) Patent Application Publication
(10) Pub. No.: US 2015/0260320 A1
(43) Pub. Date: Sep. 17, 2015

(54) FLANGE MOUNTING STRUCTURE OF A PUMP

(71) Applicant: Stairs Industrial Co., Ltd., New Taipei City (TW)

(72) Inventor: Shih-Chang HUANG, New Taipei City (TW)

(73) Assignee: STAIRS INDUSTRIAL CO., LTD., New Taipei City (TW)

(21) Appl. No.: 14/519,711

(22) Filed: Oct. 21, 2014

(30) Foreign Application Priority Data
Mar. 13, 2014 (TW) 103204282

(51) Int. Cl. F16L 23/00

(52) U.S. Cl. CPC F16L 23/00

(57) ABSTRACT

A flange mounting structure of a pump has a pump body, an adapting flange, and a retaining ring. The pump body has an inlet/outlet connection tube with an engaging groove. The adapting flange is mounted around the inlet/outlet connection tube and has an annular recess and an inner shoulder. The retaining ring engages in the engaging groove of the inlet/outlet connection tube, protrudes in the annular recess of the adapting flange, and abuts the inner shoulder of the adapting flange, such that the adapting flange can be held at a specific position on the inlet/outlet connection tube. Accordingly, processes of mounting the adapting flange on the inlet/outlet connection tube and dismounting the adapting flange from the inlet/outlet connection tube can be promptly facilitated.

### BACKGROUND OF THE INVENTION

1. Field of the Invention

The present invention relates to a flange mounting structure of a pump, especially to a flange mounting structure that facilitates mounting a flange on and dismounting the flange from a connection tube of a pump.

2. Description of the Prior Art(s)

A pump is used to draw stagnant water or to draw water from a storage tank. A conventional pump has a pump body with an inlet/outlet connection tube. The inlet/outlet connection tube has an outer groove formed in and around an outer surface of the inlet/outlet connection tube. A C-ring is mounted around the inlet/outlet connection tube and has an inner edge engaging in the outer groove of the inlet/outlet connection tube. An adapting flange is mounted around the inlet/outlet connection tube and has an inner groove formed in and around an inner annular sidewall of the adapting flange. An outer edge of the C-ring further engages in the inner groove of the adapting flange, such that the adapting flange is securely mounted on the inlet/outlet connection tube. Moreover, the adapting flange of the conventional pump is securely connected to a pipe flange of an inlet/outlet pipe via fasteners with a cushion pad held between the adapting flange and the pipe flange. Thus, water can flow between the pump body and the inlet/outlet pipe through the adapting flange and the pipe flange.

However, when mounting the adapting flange onto the inlet/outlet connection tube, a great force should be applied to the adapting flange, so as to allow the C-ring to engage in the inner groove of the adapting flange. Therefore, both mounting the adapting flange onto the inlet/outlet connection tube and dismounting the adapting flange from the inlet/outlet connection tube are troublesome and inconvenient.

To overcome the shortcomings, the present invention provides a flange mounting structure of a pump to mitigate or obviate the aforementioned problems.

### SUMMARY OF THE INVENTION

The main objective of the present invention is to provide a flange mounting structure of a pump. The flange mounting structure has a pump body, an adapting flange, and a retaining ring. The pump body has an inlet/outlet connection tube with an engaging groove. The adapting flange is mounted around the inlet/outlet connection tube and has an annular recess and an inner shoulder. The retaining ring engages in the engaging groove of the inlet/outlet connection tube, protrudes in the annular recess of the adapting flange, and abuts the inner shoulder of the adapting flange. Moreover, the retaining ring may be formed by attaching two half rings.

Thus, the adapting flange can be held at a specific position on the inlet/outlet connection tube. Moreover, processes of mounting the adapting flange on the inlet/outlet connection tube and dismounting the adapting flange from the inlet/outlet connection tube can be promptly facilitated.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a flange mounting structure of a pump in accordance with the present invention;

FIG. 2 is a perspective view of the flange mounting structure in FIG. 1;

FIG. 3 is an enlarged front view in partial section of the flange mounting structure in FIG. 1;

FIG. 4 is a cross-sectional side view of the flange mounting structure in FIG. 1; and

FIG. 5 is an enlarged cross-sectional side view of a retaining ring of the flange mounting structure in FIG. 1.

### DETAILED DESCRIPTION OF THE PREFERRED EMBODIMENTS

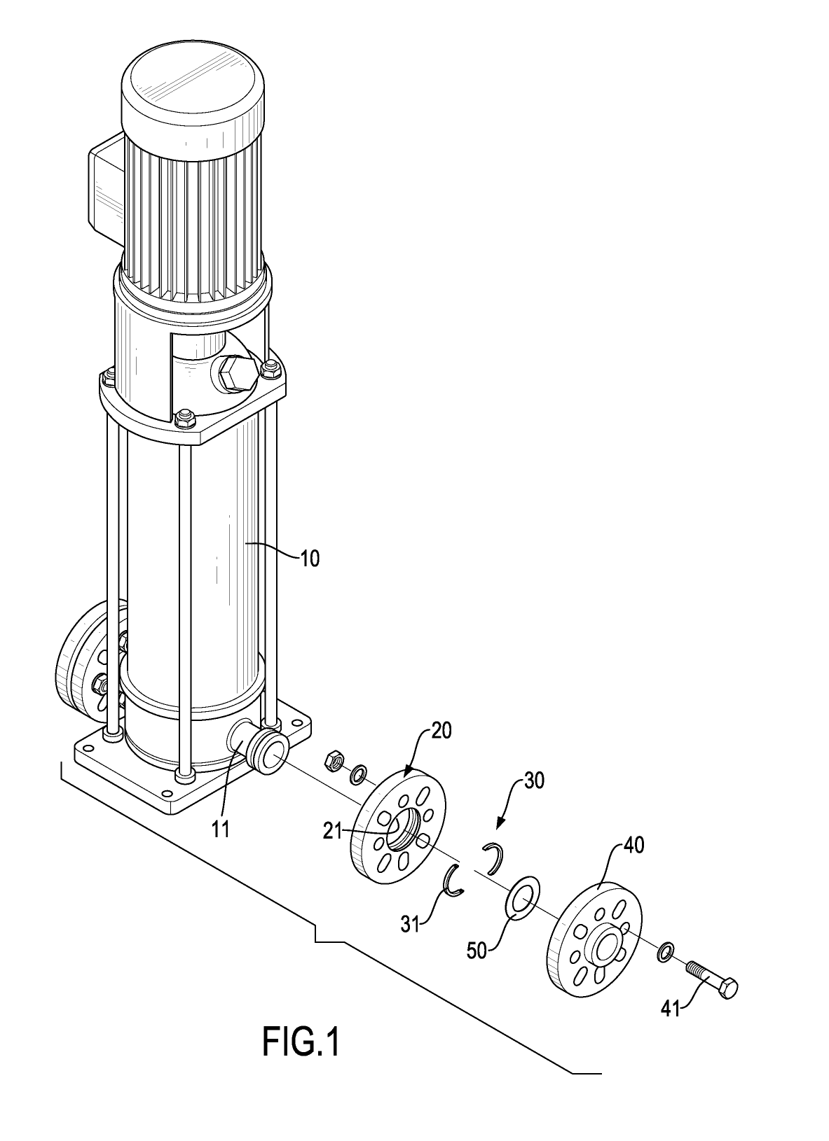

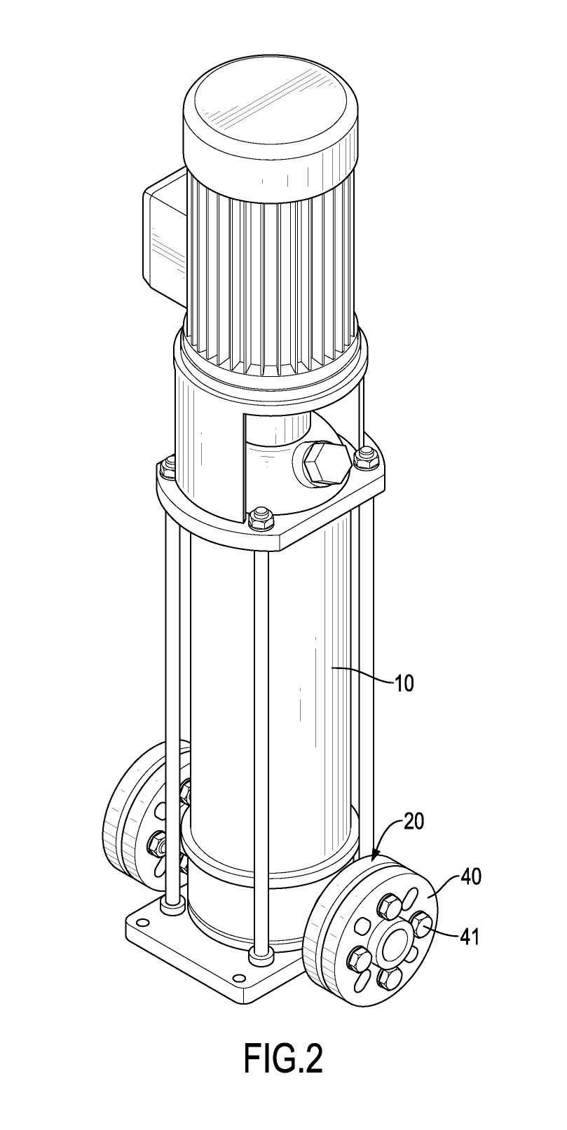

With reference to FIGS. 1 and 2, a flange mounting structure of a pump in accordance with the present invention comprises a pump body 10, an adapting flange 20, a retaining ring 30, a pipe flange 40, and a cushion pad 50.

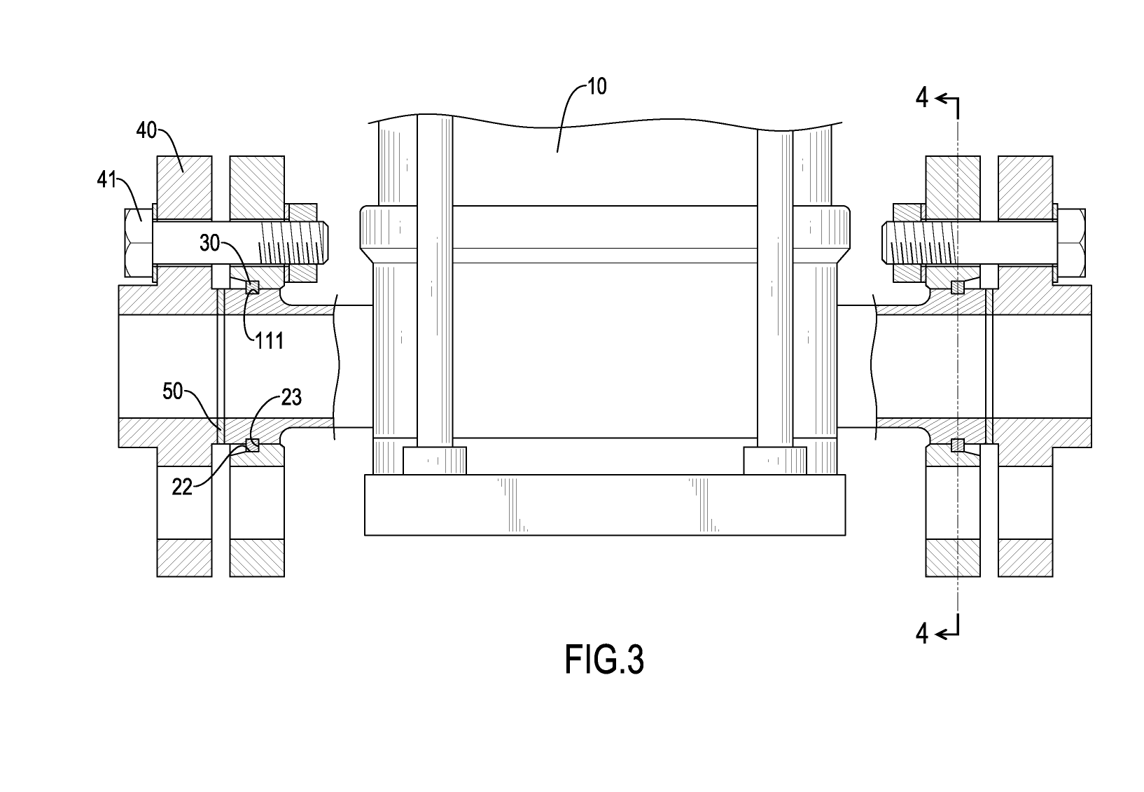

With further reference to FIG. 3, the pump body 10 has an inlet/outlet connection tube 11. The inlet/outlet connection tube 11 has a distal end, an outer surface, and an engaging groove 111. The engaging groove 111 is formed in and around the outer surface of the inlet/outlet connection tube 11.

The adapting flange 20 is mounted around the inlet/outlet connection tube 11 and has a through hole 21, an inner annular sidewall, an inner end surface, an outer end surface, and an annular recess 22. The through hole 21 is formed through the adapting flange 20. The inlet/outlet connection tube 11 protrudes through the through hole 21 of the adapting flange 20. The inner annular sidewall of the adapting flange 20 is defined around the through hole 21 of the adapting flange 20. The inner end surface of the adapting flange 20 faces the pump body 10. The outer end surface of the adapting flange 20 is opposite to the inner end surface of the adapting flange 20. The annular recess 22 is formed in and around the inner annular sidewall of the adapting flange 20 and is formed through the outer end surface of the adapting flange 20, such that an inner shoulder 23 is formed on the inner annular sidewall and around the through hole 21 of the adapting flange 20 and extends radially.

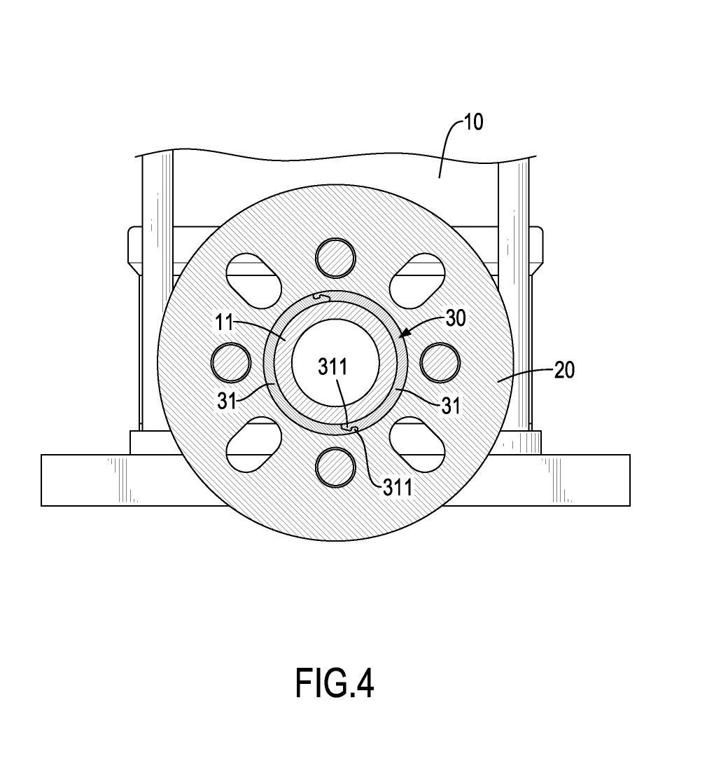

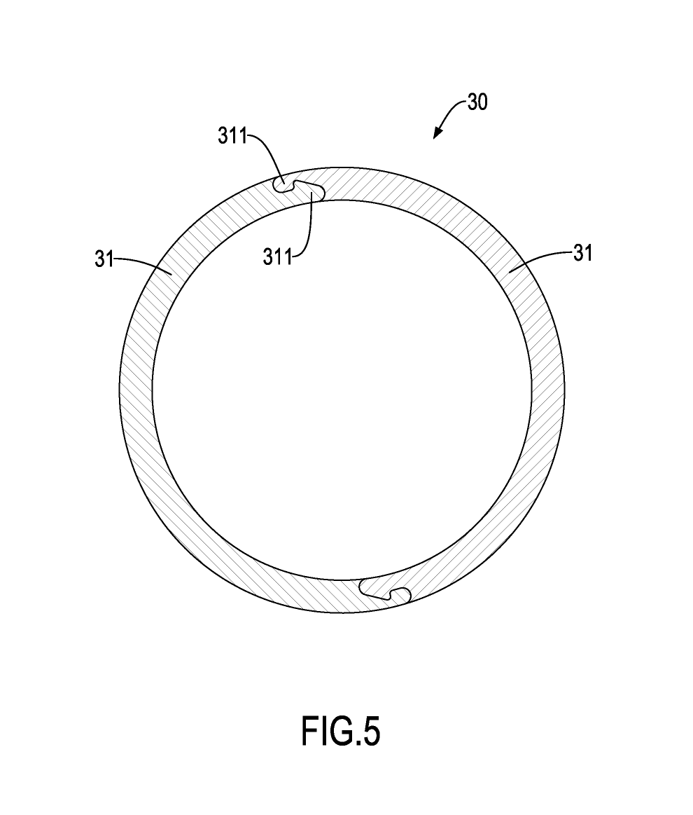

With further reference to FIGS. 4 and 5, the retaining ring 30 is mounted around the inlet/outlet connection tube 11, engages in the engaging groove 111 of the inlet/outlet connection tube 11, protrudes in the annular recess 22 of the adapting flange 20, and abuts the inner shoulder 23 of the adapting flange 20. In the preferred embodiment, the retaining ring 30 is formed by attaching two half rings 31. Each of the half rings 31 has two hooked ends 311. The hooked ends 311 of one of the half rings 31 are respectively hooked with the hooked ends 311 of the other half ring 31, such that the retaining ring 30 is formed in the form of a ring.

The pipe flange 40 is attached to an end of an inlet/outlet pipe, faces the outer end surface of the adapting flange 20, and is securely connected to the adapting flange 20 via multiple fasteners 41.

The cushion pad 50 is held between the distal end of the inlet/outlet connection tube 11 and the pipe flange 40.

As shown in FIGS. 3 to 5, when assembling the flange mounting structure of the pump as described, the adapting flange 20 is mounted around the inlet/outlet connection tube 11 and is disposed first between the engaging groove 111 and a proximal end of the inlet/outlet connection tube 11. Then the retaining ring 30 is mounted around the inlet/outlet connection tube 11 to engage in the engaging groove 111. As the adapting flange 20 is pushed toward the retaining ring 30, the retaining ring 30 further engages in the annular recess 22 and abuts the inner shoulder 23 of the adapting flange 20. Thus, the adapting flange 20 is held at a specific position on the inlet/outlet connection tube 11 and can be connected to the pipe flange 40 via the fasteners 41. With the cushion pad 50 held between the distal end of the inlet/outlet connection tube 11 and the pipe flange 40, fluid flowing through the inlet/outlet connection tube 11 and the inlet/outlet pipe does not leak. Moreover, the two half rings 31 that form the retaining ring 30 can be first mounted into the engaging groove 111 of the inlet/outlet connection tube 11 separately, and then hook each other. Accordingly, processes of mounting the adapting flange 20 on the inlet/outlet connection tube 11 and dismounting the adapting flange 20 from the inlet/outlet connection tube 11 can be promptly facilitated.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A flange mounting structure of a pump comprising:
a pump body having an inlet/outlet connection tube, the inlet/outlet connection tube having an engaging groove formed in and around an outer surface of the inlet/outlet connection tube;
an adapting flange mounted around the inlet/outlet connection tube and having
a through hole for the inlet/outlet connection tube to protrude through the through hole of the adapting flange;
an inner annular sidewall defined around the through hole of the adapting flange;
an outer end surface;
an annular recess formed in and around the inner annular sidewall of the adapting flange and formed through the outer end surface of the adapting flange; and
an inner shoulder formed on the inner annular sidewall and around the through hole of the adapting flange and extending radially; and
a retaining ring mounted around the inlet/outlet connection tube, engaging in the engaging groove of the inlet/outlet connection tube, protruding in the annular recess of the adapting flange, and abutting the inner shoulder of the adapting flange.

2. The flange mounting structure as claimed in claim 1, wherein the retaining ring is formed by attaching two half rings.

3. The flange mounting structure as claimed in claim 2, wherein each of the half rings has two hooked ends, and the hooked ends of one of the half rings are respectively hooked with the hooked ends of the other half ring.

4. The flange mounting structure as claimed in claim 1 further comprising a pipe flange attached to an end of an inlet/outlet pipe, facing the outer end surface of the adapting flange, and securely connected to the adapting flange via multiple fasteners.

5. The flange mounting structure as claimed in claim 2 further comprising a pipe flange attached to an end of an inlet/outlet pipe, facing the outer end surface of the adapting flange, and securely connected to the adapting flange via multiple fasteners.

6. The flange mounting structure as claimed in claim 3 further comprising a pipe flange attached to an end of an inlet/outlet pipe, facing the outer end surface of the adapting flange, and securely connected to the adapting flange via multiple fasteners.

7. The flange mounting structure as claimed in claim 4, wherein
the inlet/outlet connection tube of the pump body further has a distal end; and
the flange mounting structure further comprises a cushion pad held between the distal end of the inlet/outlet connection tube and the pipe flange.

8. The flange mounting structure as claimed in claim 5, wherein
the inlet/outlet connection tube of the pump body further has a distal end; and
the flange mounting structure further comprises a cushion pad held between the distal end of the inlet/outlet connection tube and the pipe flange.

9. The flange mounting structure as claimed in claim 6, wherein
the inlet/outlet connection tube of the pump body further has a distal end; and
the flange mounting structure further comprises a cushion pad held between the distal end of the inlet/outlet connection tube and the pipe flange.
